(19) United States
(12) Patent Application Publication
(10) Pub. No.: US 2026/0127582 A1
(43) Pub. Date: May 7, 2026

(54) System, Method, and Device for Device-Agnostic Services

(71) Applicant: The Toronto-Dominion Bank, Toronto (CA)

(72) Inventor: Arash DELJAVAN FARSHI, Richmond Hill (CA)

(73) Assignee: The Toronto-Dominion Bank, Toronto (CA)

(21) Appl. No.: 18/935,111

(22) Filed: Nov. 1, 2024

(51) Int. Cl. G06Q 20/38; G06Q 20/04; G06Q 20/40

(52) U.S. Cl. CPC G06Q 20/382; G06Q 20/047; G06Q 20/401

(57) ABSTRACT

A system and method provide device agnostic services. The method includes providing a device agnostic gateway having a channel to communicate with a transaction device, the device agnostic gateway positioned between the transaction device and a transaction participant system. The method also includes receiving, from a client device, a request to complete a transaction, the request comprising identifying information and, by the transaction device, processing the request to complete the transaction via a service provider, the transaction requiring the transaction participant system. The method also includes receiving a token based on the identifying information of the first request and provide the token to the device agnostic gateway; transmitting, with the device agnostic gateway, the token to a subsystem of the transaction participant system to associate the token with transaction details of the transaction available to the transaction participant system; and providing, via the device agnostic gateway, the transaction details in response to receiving the identifying information.

### TECHNICAL FIELD

The following relates generally to methods for device-agnostic services.

### BACKGROUND

Many existing services are found to be fragmented. Some existing service providers create relatively closed ecosystems, whether via hardware or software, where communication between different aspects of, or between, service(s) is/are difficult. Technological change also creates interrelationships between aspects of a service that did not exist beforehand, which legacy technical infrastructure does not support. Some services or aspects of a service are required to respond to regulatory regimes (e.g., also managing sensitive information) which can require technical infrastructure that is difficult to navigate or access.

From a customer's point of view, the fragmentation leads to an undesirable opacity. Managing the data access of various service providers, navigating the various service providers to access of service, managing the technical requirements of the various service providers, can be difficult when customers lack insight into the process, or the market requires them to use the fragmented service(s).

In one example, merchants may use point-of-sale (POS) devices that are sold and supported by various financial institutions, or POS devices that are supported by a third party, etc. Such POS devices accept payments from accounts that are either part of that financial institution or from another financial institution. These POS devices can include proprietary software or vendor configurations, or themselves may be vendor specific. Retail customers of the merchants therefore are unable to understand how their data is used, have a difficult time collating data from different service providers, etc. The merchant can have difficulty maintaining different services from different service providers.

From the retail customer's perspective, to use an example, getting a consistent digital receipt from different merchants may require the use of a plurality of applications, and they may be uncertain as to what personal information is being collected by the various applications. Existing solutions include “digital receipts” being provided by the merchant (e.g., by emailing a copy) using a separate system.

### BRIEF DESCRIPTION OF THE DRAWINGS

Embodiments will now be described with reference to the appended drawings wherein:

FIG. 1 is a schematic diagram of an example computing environment.

FIG. 2 is a block diagram illustrating an example framework for providing device agnostic services.

FIG. 3 is a block diagram illustrating additional details of the example framework for providing device agnostic services.

FIG. 4 is a flow chart illustrating operations that may be performed in providing device agnostic services.

FIG. 5 is a flow chart illustrating operations that may be performed in processing a subsequent request for transaction details.

FIG. 6 is a flow chart illustrating operations that may be performed in token matching for returning stored transaction details.

FIG. 7 is a flow chart illustrating operations that may be performed in sending a notification to an event notification system.

FIG. 8 is a block diagram of an example configuration of a digital receipt service.

FIG. 9 is a block diagram of an example configuration of an enterprise system.

FIG. 10 is a block diagram of an example configuration of a computing device such as a POS device or a client computing device associated with a user, customer, or client.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It will be appreciated that the use of singular terms such as “a” or “an,” in this description is not intended to be limited to instances of solely one object, unless explicitly recited as such. That is, for ease of reference and/or simplicity, the description, for example, may use the term “a” to represent a or multiple components. Similarly, the use of plural terminology, is not intended to limit this disclosure to aspects where multiple (as compared to singular) components are required. For example, “various servers” can refer to a single server, multiple servers of the same kind, or multiple servers of different kinds, etc.

There is found to be no seamless experience for customers to re-issue digital receipts or set their preferences per merchant or services. There is a need to address this technical problem to provide a richer experience for users, in particular if they are using payment cards or a mobile application (app) for the financial institution that hosts/provides the POS.

The following generally relates to system, methods and services that store transaction-related data in a way that enables a financial institution to provide a digital receipt option to merchants across different terminals using an intermediary's service and event streaming to send them to a customer as per their choice. This solution involves a device agnostic gateway and a cloud based digital receipt service using event streaming to provide the digital receipt notifications to card holders. An important improvement is in removing device and vendor dependencies to support this service across existing and future devices as well as being independent of the normal payment authorization flow.

According to one aspect, a system for providing device agnostic services is disclosed, e.g., for providing digital receipts. The system includes a processor, a communication module coupled to the processor, and a memory coupled to the processor. The memory stores computer executable instructions that when executed by the processor cause the system to provide a device agnostic gateway having a channel to communicate with a transaction device, the device agnostic gateway positioned between the transaction device and a transaction participant system; receive, from a client device, a request to complete a transaction, the request comprising identifying information; by the transaction device, process the request to complete the transaction via a service provider, the transaction requiring the transaction participant system; receive a token based on the identifying information of the first request and provide the token to the device agnostic gateway; transmit, with the device agnostic gateway, the token to a subsystem of the transaction participant system to associate the token with transaction details of the transaction available to the transaction participant system; and provide, via the device agnostic gateway, the transaction details in response to receiving the identifying information.

In certain example embodiments, the token is generated by the service provider and the identifying information comprises sensitive payment information.

In certain example embodiments, the transaction device is a point of sale device, the transaction participant system is a financial institution, and the notification includes a digital receipt.

In certain example embodiments, the transaction device is configured to process the transaction prior to receiving the token to avoid latency.

In certain example embodiments, the transaction is completed via another channel, and the token is provided to the device agnostic gateway via the communication channel.

In certain example embodiments, the device agnostic gateway parses traffic received via the communication channel to determine whether the transaction device is authenticated for the device agnostic gateway.

In certain example embodiments, the notification is provided automatically in response to the token being submitted to the subsystem.

In certain example embodiments, the instructions cause the system to receive a subsequent request comprising subsequent identifying information for the transaction details from a further device; query the service provider to receive a subsequent token based on the subsequent identifying information; and in response to determining that the subsequent token matches the token, provide the further device with the transaction details.

In certain example embodiments, the instructions cause the system to store transactions details in a database on the subsystem in association with the token; and in response to the subsequent token matching the token, return stored transaction details in the database.

In certain example embodiments, the instructions cause the system to in response to the subsystem receiving the token, transmit, by the subsystem, a notification to an event notification system responsible for managing notification preferences.

In certain example embodiments, the notification system generates a notification and transmits the notification to a client device associated with the token.

In certain example embodiments, the notification system is an event notification system for the transaction participant system, and the event notification system transmits notifications via a selected channel with the transaction details.

In certain example embodiments, the device agnostic gateway provides another channel for communication with client devices for subsequent requests for the transaction details.

In another aspect, a method for providing device agnostic services is disclosed. The method includes providing a device agnostic gateway having a channel to communicate with a transaction device, the device agnostic gateway positioned between the transaction device and a transaction participant system; receiving, from a client device, a request to complete a transaction, the request comprising identifying information; by the transaction device, processing the request to complete the transaction via a service provider, the transaction requiring the transaction participant system; receiving a token based on the identifying information of the first request and provide the token to the device agnostic gateway; transmitting, with the device agnostic gateway, the token to a subsystem of the transaction participant system to associate the token with transaction details of the transaction available to the transaction participant system; and providing, via the device agnostic gateway, the transaction details in response to receiving the identifying information.

In certain example embodiments, the token is generated by the service provider and the identifying information comprises sensitive payment information.

In certain example embodiments, the transaction device is a point of sale device, the transaction participant system is a financial institution, and the notification includes a digital receipt.

In certain example embodiments, the transaction device is configured to process the transaction prior to receiving the token to avoid latency.

In certain example embodiments, the method further includes receiving a subsequent request comprising subsequent identifying information for the transaction details from a further device; querying the service provider to receive a subsequent token based on the subsequent identifying information; and in response to determining that the subsequent token matches the token, provide the further device with the transaction details.

In certain example embodiments, the device agnostic gateway provides another channel for communication with client devices for subsequent requests for the transaction details.

In another aspect, a computer readable medium for providing device agnostic services is disclosed. The computer readable medium stores computer executable instructions that when executed by a processor of a computing system, perform operations including providing a device agnostic gateway having a channel to communicate with a transaction device, the device agnostic gateway positioned between the transaction device and a transaction participant system; receiving, from a client device, a request to complete a transaction, the request comprising identifying information; by the transaction device, processing the request to complete the transaction via a service provider, the transaction requiring the transaction participant system; receiving a token based on the identifying information of the first request and provide the token to the device agnostic gateway; transmitting, with the device agnostic gateway, the token to a subsystem of the transaction participant system to associate the token with transaction details of the transaction available to the transaction participant system; and providing, via the device agnostic gateway, the transaction details in response to receiving the identifying information.

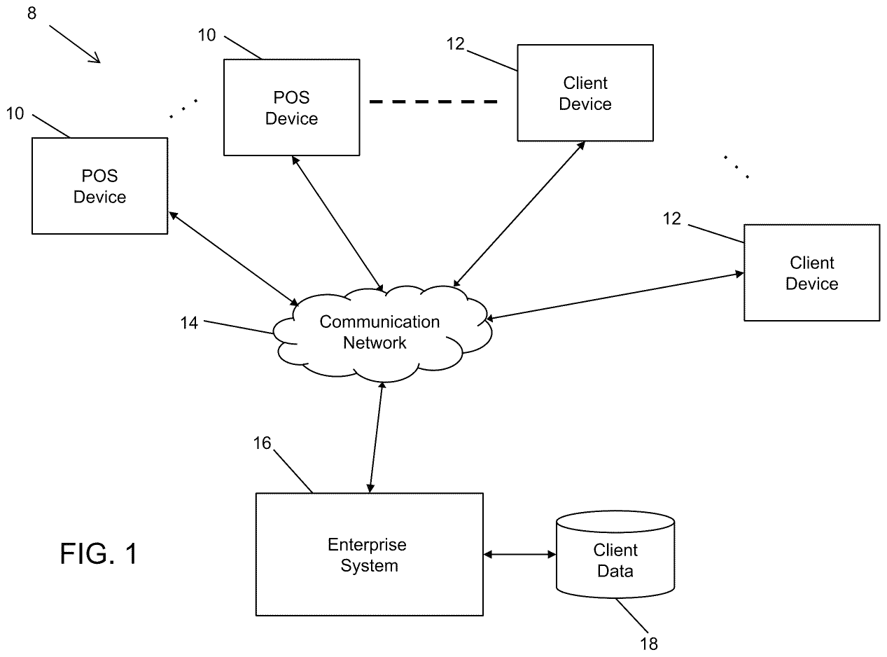

Referring now to the figures, FIG. 1 illustrates an example of a computing environment 8. In one aspect, the computing environment 8 may include one or more POS devices 10, one or more client devices 12, and one or more communications networks 14 connecting the components of the computing environment 8.

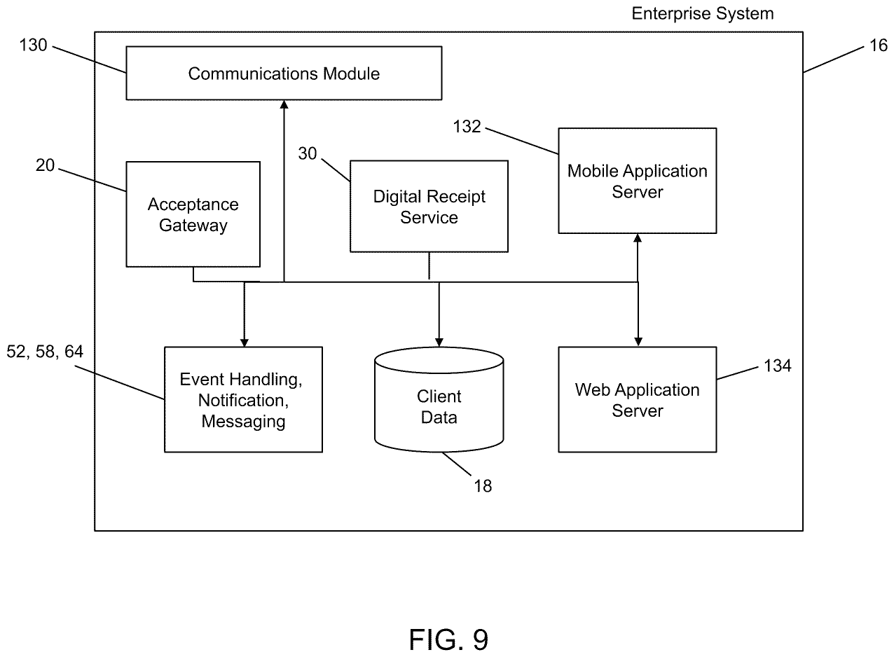

The computing environment 8 may also include an enterprise system 16 (e.g., a financial institution such as commercial bank and/or insurance provider) that provides financial services accounts to users and processes financial transactions associated with those financial service accounts. While several details of the enterprise system 16 have been omitted for clarity of illustration, reference will be made to FIG. 9 below for additional details.

The enterprise system 16 includes or otherwise has access to a datastore for storing client data 18. The enterprise system 16 may include other datastores not shown in FIG. 1. The data associated with a user can include client profile data that may be mapped to corresponding financial data for that user. It can be appreciated that the financial data could also include transaction data and/or the client data 18 shown in FIG. 1 and these datastores are described separately for illustrative purposes. The client data 18 can include both data that is associated with a client as well as data that is associated with one or more user accounts for that client as recognized by the computing environment 8.

The data associated with a client may include, without limitation, demographic data (e.g., age, gender, income, location, etc.), preference data input by the client, and inferred data generated through machine learning, modeling, pattern matching, or other automated techniques. The client data 18 may also include historical interactions and transactions associated with the enterprise system 16, e.g., login history, search history, communication logs, documents, etc.

The POS device 10 may be a specialized mobile or integrated computing device for completing transactions such as retail transactions. The POS device 10 may be portable or integrated with a retail counter and other checkout system(s). The POS device 10 may include an onboard printer and store paper for printing paper receipts and may include at least one data connection to receive and transmit details of a transaction as is known in the art. The POS device 10 can be affiliated with the enterprise system 16 or be operated by a different entity than the enterprise system 16, such as a third-party payment terminal provider. The third-party payment terminal provider may be another financial institution.

Client devices 12 may be associated with one or more users. Users may be referred to herein as customers, clients, policy holders, correspondents, or other entities that interact with the enterprise system 16 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with a mobile or web-based financial (banking) application which uses or incorporates subsystems of the enterprise system 16, discussed further below.

The client devices 12 and/or POS devices 10 can access information within the enterprise system 16 or a remote computing environment associated with the enterprise system 16 in a variety of ways. For example, the client device 12 can access the enterprise system 16 via a web-based application, or a dedicated application. Access can require the provisioning of different types of credentials (e.g., login credentials, two factor authentication, etc.). In example embodiments, each different device 10, 12 can be provided with a unique degree of access, or variations thereof. For example, the client device 12 can be provided with a greater degree of access to the enterprise system 16 compared to the POS device 10.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

The POS device 10 may be embodied using a device similar to that used as a client device 12 or may be a customized device such as a portable terminal or other form of portable unit.

Communication network 14 may include a telephone network, cellular, and/or data communication network to connect different types of POS devices 10 and/or client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 6 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Financial institutions can generate vast amounts of data, and have vast amounts of existing records, both of which can be difficult to migrate into a digital and remote computing environment.

The enterprise system 16 may include both on-premises and remote computing assets provided by a remote computing environment—not shown (hereinafter referred to in the alternative as computing resources). The remote computing environment includes resources used by, or available, to the enterprise system 16 that are stored or managed by a party other than operator of the enterprise system 16. For example, the computing resources can include cloud-based storage services (e.g., database(s)). In at least some example embodiments, the computing resources include one or more tools developed or hosted by the external party, or tools for interacting with the computing resources. In at least one contemplated embodiment, the tool (referred to in the singular for ease of reference) is a tool for managing data lakes, and more specifically a tool for scheduling writing to a data lake associated with the Microsoft™ Azure™0 data storage and processing platform. Further particularizing the example, the tool can allow a client device 12 to access the computing resources, and to thereafter configure an ingestion procedure wherein different data files are assigned to different processors (e.g., hardware) within the computing resources based on a configuration file. The tool can be or include aspects of a machine learning tool, or a tool associated with the Delta Lake Storage (ALDS)™ suite, etc. The computing resources can also include hardware resources, such as access to processing capability of server devices (e.g., cloud computing), and so forth.

Referring back to FIG. 1, the enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the financial data and/or client data 18 by way of encryption for data protection, digital signatures or message digests for data integrity, and by using digital certificates to authenticate the identity of the users and client devices 12, POS devices 10, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

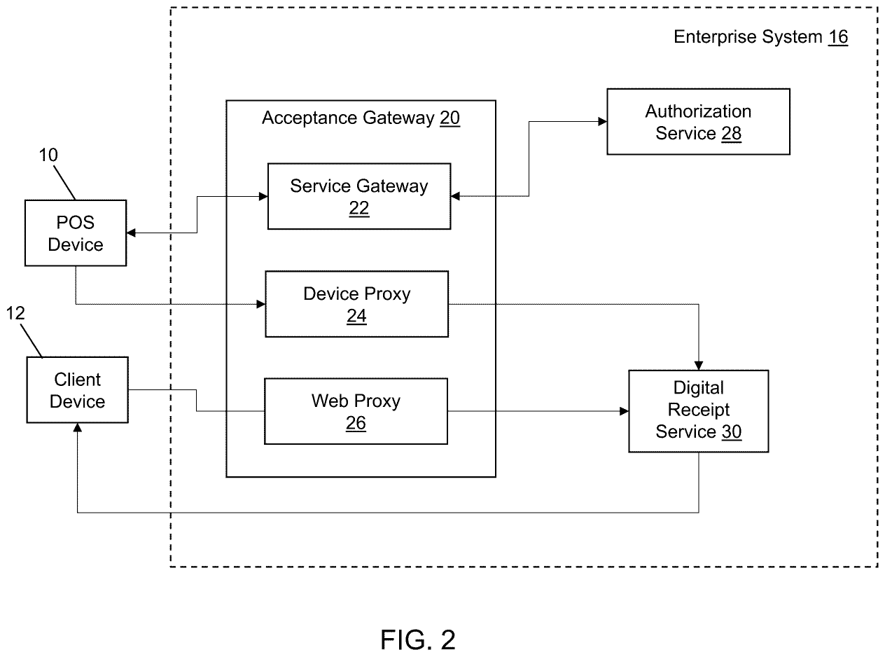

FIG. 2 provides a schematic illustration of a device agnostic system that may be implemented in or in connection with the enterprise system 16. The enterprise system 16 may provide an acceptance gateway 20, which provides device agnostic gateway and proxy functionality for interacting with a digital receipt service 30. The POS device 10 in this configuration is in communication with a service gateway 22, which is coupled to an authorization service 28 to perform typical transaction-related authorizations, e.g., to determine if an account related to a card being used at the POS device 10 has sufficient funds to complete a given transaction. The POS device 10 may also be coupled to a device proxy 24 to enable the POS device 10 to interface with the digital receipt service 30 to enable digital receipts to be stored and communicated to a user.

It can be appreciated that the POS device 10 may be associated with the client device 12 in that the user interacting with the POS device 10 in order to complete a transaction may possess the client device 12 as a personal communication device (e.g., smartphone), which may store an electronic version of the transaction card and/or be used to obtain a digital receipt through another channel, such as SMS, email, push notifications, etc.

The client device 12 can interface with the acceptance gateway 20 via a web proxy 26. The web proxy 26 enables any device, i.e., devices other than a POS device 10 to obtain a transaction-related receipt or digital receipt upon request. Similarly, transactions performed via the client device 12 (i.e. without using a POS device 10) may be directed through the web proxy 26 to obtain the appropriate tokens to permit transaction data to be captured, stored, and disseminated via a digital receipt. The device proxy 24 and web proxy 26 thus provide a gateway to the digital receipt service 30.

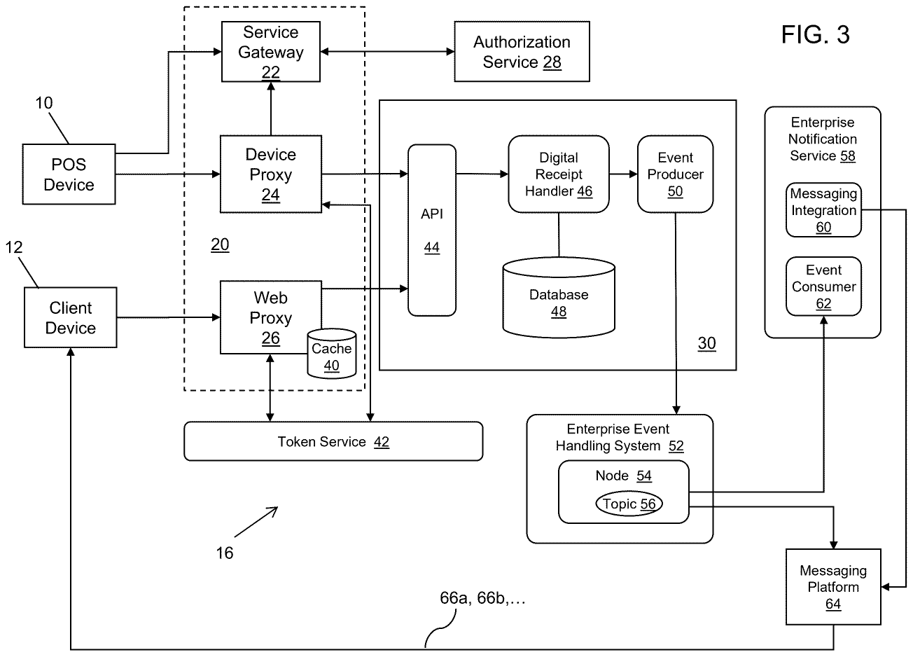

The digital receipt service 30 may include other sub-systems or be integrated with other systems in or related to the enterprise system 16, e.g., as shown in FIG. 3 described below. This allows the digital receipt service 30 to feed data back to a client device 12, e.g., to provide a requested digital receipt. By utilizing the digital receipt service 30, transaction data that is otherwise stored by a merchant system or captured only in a paper receipt can be captured and stored within the enterprise system 16 (e.g., within a financial institution providing accounts to users of the client devices 12 and/or POS devices 10). The POS device 10 may therefore communicate with the authorization service 28 via the service gateway 22 to engage in a financial transaction, which uses the authorization service 28 to generate a token for the card that is used at the terminal and this token is returned to the POS device 10.

By also being coupled to the device proxy 24, the POS device 10 is able to initiate a digital receipt creation process and/or perform non-financial transactions with the digital receipt service 30. The client device 12 may communicate with the digital receipt service 30 via the web proxy 26, provided to cardholders or other devices used in the transactions, to look up a digital receipt, as discussed in greater detail below. One or more channels may connect the digital receipt service 30 back to the client device 12 as illustrated in FIG. 2, to provide the requested digital receipt via email, SMS, push notification via an app, etc. The digital receipt may, additionally or alternatively, be provided automatically or by selecting an option when completing the transaction at the POS device 10.

FIG. 3 illustrates additional details of a configuration for the digital receipt service 30 as integrated into the enterprise system 16 and various subsystems of the enterprise system 16 to enable digital receipts to be created, captured, stored, retrieved, and sent.

As shown in FIG. 3, using an existing service gateway 22, the POS device 10 obtains an authorization from the authorization service 28. This has a transaction token generated for the card used at the POS device 10 and returns the transaction token to the POS device 10.

The transaction token includes various information, such as a POS ID, a Merchant ID, a transaction number, paper receipt detail and breakdown (i.e. what is/would be printed on a normal physical receipt), cardholder contact (e.g., phone and/or email), and the receipt method. The receipt method enables the user to obtain the receipt using various digital means, including a QR code, text, email, etc. The POS device 10 can include a function to allow the user to select the receipt method (e.g., a button press). The QR could be displayed by the POS device 10 to provide a link directly to the digital receipt, e.g., using a client device 12.

To make the system device agnostic, the device proxy 24 and the web proxy 26 are provided. The web proxy 26 may include a cache 40 for temporarily storing requests for digital receipts and/or the digital receipts themselves. For registered POS devices 10 (e.g., with a profile in the enterprise system 16), only self-contained logic is used to verify authorized POS devices 10 and valid payloads. This is handled by communicating with the device proxy 24. The self-contained logic isolates the communications via the device proxy 24 from the backend subsystems to enable the digital receipt process to occur without disrupting those backend subsystems. Other unknown devices (e.g., client devices 12) may connect via the web proxy 26, which gets a receipt token from a token service 42. Obtaining a receipt token from the token service 42 is also done by the device proxy 24. The gateway 20 is used to translate the payload from the POS device 10 in a secure manner and this is done outside of the backend of the enterprise system 16 for security purposes. The gateway 20 (using the proxies 24, 26) also gets receipt tokens on behalf of the client devices 12 and receives the same payload that a printer would in order to print a paper receipt. The transaction tokens and receipt tokens may be separate or used to create a single token for the system. For example, the transaction token that is issued using an existing authorization workflow may be used to create the receipt token by the token service 42. Separate tokens may instead be used to verify that a transaction is associated with the details stored by the digital receipt service 30, e.g., by comparing the tokens or details therein to confirm that the requestor is authorized to obtain the digital receipt based on possessing the original transaction token that was issued by the authorization service 28.

The digital receipt service 30 is positioned behind the access gateway 20. The API 44 uses an API token service 42 to obtain a receipt token. The API 44 also initiates authorization with a digital receipt handler 46. The digital receipt handler 46 creates events via an event producer 50 to create notification topics 56 in a node 54 of an enterprise event handling system 52 (e.g., Kafka) to generate the digital receipts. The digital receipt handler 46 also stores a copy of the digital receipt and any associated information like the card token (if available) in the receipt database 48, such that users can later request copies of the digital receipts. An event notification service 58 provides an event consumer 62 that subscribes to the topic 56 in the event handling node 54 to listen for events published via the enterprise event handling system 52, to generate the notifications. In this example, the enterprise notification service 58 uses a messaging integration 60 to interface with a messaging platform 64. The messaging platform 64 may be an existing push notification or SMS/email-based notification service used by the enterprise system 16. However, any notification system can be coupled to the digital receipt service 30. This allows multiple channels 66a, 66b, . . . to be used to deliver a requested or automatically provided digital receipt to the client device 12.

The digital receipt service 30 can be configured to operate with any HTTP-based devices (e.g., POS device 10, client device 12, etc.), and can prepare the response to a request based on from which device 10, 12 or merchant the digital receipt request is coming from, as well as what is in the payload.

The digital receipt service 30 can also transfer the digital receipt selection option from the POS device 10 to a cardholder device (e.g., client device 12) via QR code based on the specific device model. This can allow for enhanced user experiences while avoiding the need to print a receipt. For example, the POS device 10 can present the QR code to the user to be scanned and initiate a digital receipt delivery. In this case, the POS device's software would not need to show the selection and the web page or other medium in which the digital receipt notification is displayed, can be shown on the client device 12 where they can select the digital receipt preference option.

It can be appreciated that any number of gateways can be provided by the access gateway 20, to integrate with other services while providing the same security protections as that shown in FIG. 3. For example, additional gateways or proxies can be spun up to enable value add services, e.g. loyalty card, membership cards, etc. This can be done by allowing services to be added on top of the access gateway 20.

In general, the system shown in FIG. 3 provides a device agnostic configuration by providing a single gateway service that decouples the digital receipt authorization and handling from the backend financial institution to handle end devices without disrupting current backend operations. The architecture can also be extended to allow for the delivery and storage of other digital assets related to a transactions (e.g., loyalty, warranty, etc.). That is, the term “digital receipt” as used herein is one example of a digital asset, or any identifying information related to such an asset or item and the principles herein should not be limited to transactions related to purchases via a POS device 10.

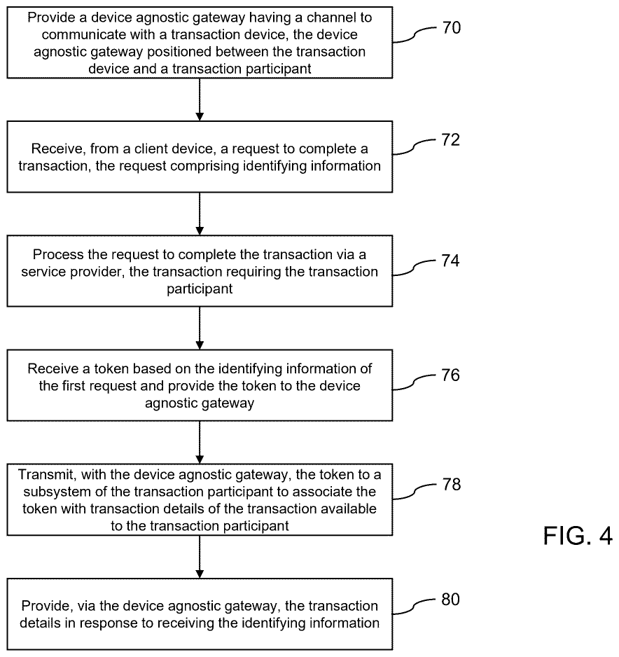

FIG. 4 is a flow chart illustrating operations that may be executed by the system(s) described herein for providing device agnostic services. For ease of illustration, reference shall be made to elements of the preceding figures to discuss the example flow diagram. It is understood that such reference is not intended to be limiting.

At block 70, the digital receipt service 30 and/or the enterprise system 16 provides a device agnostic gateway (e.g., acceptance gateway 20) having a channel to communicate with a transaction device (e.g., the service gateway 22 and the device proxy 24). The device agnostic gateway is positioned between the transaction device 10 and a transaction participant system, e.g., the enterprise system 16 or an entity which is connected to the enterprise system 16 via a client device 12 or otherwise.

At block 72, the digital receipt service 30 receives, from a client device 12, a request to complete a transaction. The request includes identifying information. Using the transaction device, the system may process the request at block 74, to complete the transaction via a service provider, in association with the transaction participant system such as the enterprise system 16.

At block 76, the digital receipt service 30 may receive a token based on the identifying information of the request and provide the token to the device agnostic gateway, e.g., by the client device 12 via the web proxy 26.

At block 78, the device agnostic gateway may transmit the received token to a subsystem of the transaction participant system to associate the token with transaction details of the transaction available to the transaction participant system. For example, the client device 12 may use the transaction token to request a digital receipt, which is associated with a receipt token issued by the token service 42.

At block 80, the digital receipt service 30 provides, via the device agnostic gateway, the transaction details in response to receiving the identifying information. For example, the digital receipt handler 45 may use the event producer to post a topic 56 to have the digital receipt sent via the messaging platform 64.

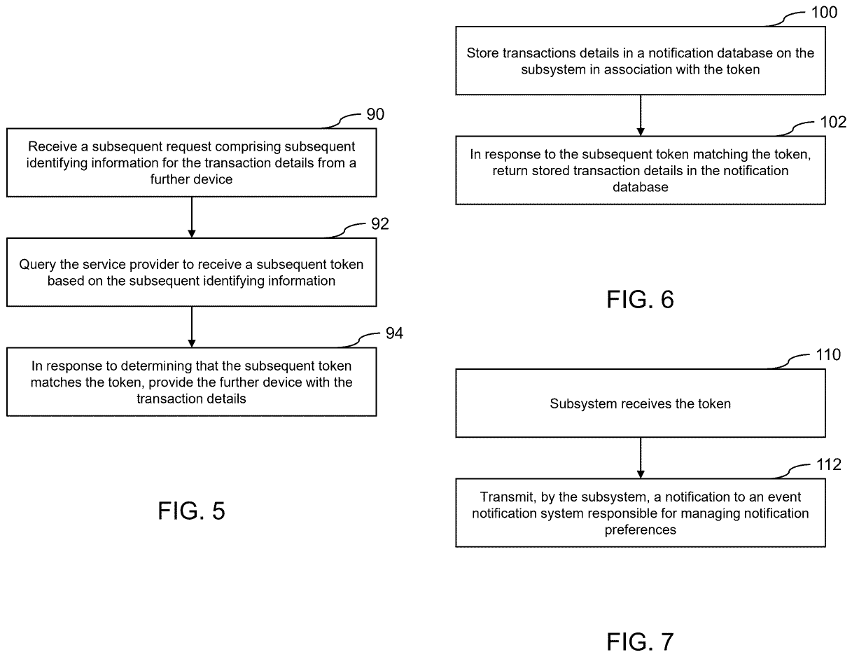

FIG. 5 is a flow chart illustrating operations that may be executed by the system(s) described herein for processing a subsequent request for transaction details. For ease of illustration, reference shall be made to elements of the preceding figures to discuss the example flow diagram. It is understood that such reference is not intended to be limiting.

At block 90, the digital receipt service 30 receives a subsequent request that includes subsequent identifying information for the transaction details from a further device, e.g., a client device 12.

At block 90, the digital receipt service 30 may query the service provider such as digital receipt handler 46 to receive a subsequent token based on the subsequent identifying information.

At block 92, in response to determining that the subsequent token matches the token that was originally produced by the token service 42, the digital receipt service 30 provides the further device with the transaction details.

FIG. 6 is a flow chart illustrating operations that may be executed by the system(s) described herein for in token matching for returning stored transaction details. For ease of illustration, reference shall be made to elements of the preceding figures to discuss the example flow diagram. It is understood that such reference is not intended to be limiting.

At block 100, the digital receipt service 30 stores transaction details in the database 48 on the subsystem in association with the token.

At block 102, in response to the subsequent token matching the token originally stored, the digital receipt service may return stored transaction details in the database 48.

FIG. 7 is a flow chart illustrating operations that may be executed by the system(s) described herein for sending a notification to an event notification system. For ease of illustration, reference shall be made to elements of the preceding figures to discuss the example flow diagram. It is understood that such reference is not intended to be limiting.

At block 110, the digital receipt service 30 subsystem receives the token. At block 112, the digital receipt service 30 transmit a notification to an event notification system such as to a node 54 in the enterprise event handling system 52, which is responsible for managing notification preferences. This allows an event consumer 62 to listed to the topic 56 and determine that a notification with transaction details should be sent to the client 12 via a channel 66.

In general, as illustrated in FIGS. 4 to 7, the enterprise system 16 may deploy a digital receipt service 30 as a subsystem to integrate the handling of transaction and receipt tokens, which may be used to authenticate a transaction or user to fetch transaction details stored within the enterprise system 16. In this way, the digital receipt may be issued in real-time (e.g., by using the transaction token at the POS device 10 at the time of the transaction) or at a later time (e.g., by having a client device 12 or POS device 10 furnish a previously-issued token to match with tokens stored by the digital receipt handler 46). By integrating with other subsystems such as the event handling system 52, notification service 58 and messaging platform 64 these other subsystems can be leveraged to enable delivery of a digital receipt to a requestor that possesses the correct credentials, e.g., a token that can be matched to one stored by the system.

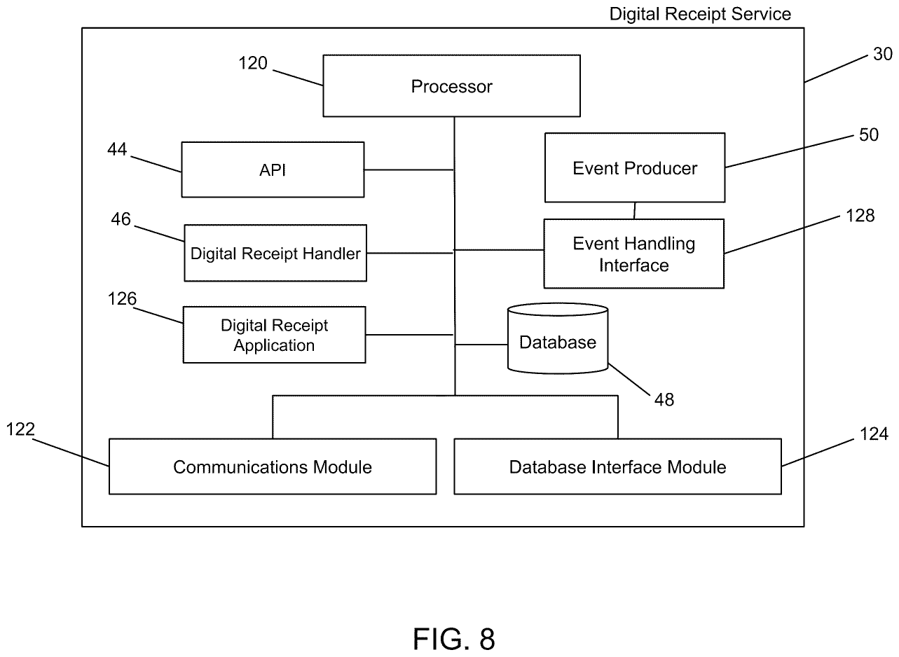

In FIG. 8, an example configuration of the digital receipt service 30 is shown. In certain embodiments, the digital receipt service 30 may include one or more processors 120, a communications module 122, and a database interface module 124 for interfacing with the receipt database 48 (and if permitted client data 18) to retrieve, modify, and store (e.g., add) data. Communications module 122 enables the digital receipt service 30 to communicate with one or more other components of the computing environment 8, such as client device 12 or POS device 10 (or one of its components), via a bus or other communication network, such as the communication network 14 via the service gateway 20. While not delineated in FIG. 8, the digital receipt service 30 includes at least one memory or memory device that can include a tangible and non-transitory computer-readable medium having stored therein computer programs, sets of instructions, code, or data to be executed by processor 120. FIG. 8 illustrates examples of modules, tools and engines stored in memory on the digital receipt service 30 and operated or executed by the processor 120. It can be appreciated that any of the modules, tools, and engines shown in FIG. 8 may also be hosted externally and be available to the digital receipt service 30, e.g., via the communications module 122. In the example embodiment shown in FIG. 8, the digital receipt service 30 includes the API 44 and the digital receipt handler 46 described above, a digital receipt application 126 for enabling digital receipts to be requested, e.g., via client device 12 as discussed above. The digital receipt service 30 may also include the event producer 50 and an event handling interface 128 for enabling it to communicate with the event handling system 52.

While not shown in FIG. 8, it can be appreciated that the digital receipt service 30 can also include a machine learning module and recommendation engine to enable the digital receipt service 30 to analyze client data 18 or receipt-related data from the receipt database 48 to recommend other products or services or potential changes to a product or service, e.g., based on what other users have done. Such a recommendation engine may utilize or otherwise interface with the machine learning engine to both classify data currently being analyzed to generate a suggestion or recommendation, and to train classifiers using data that is continually being processed and accumulated by the digital receipt service 30. This can result in a trained model used by the digital receipt service 30 to perform such operations.

While not shown in FIG. 8, the digital receipt service 30 may also include an access control module used to apply a hierarchy of permission levels or otherwise apply predetermined criteria to determine what client data 18, receipt data 48, or other financial data can be shared with which entity in the computing environment 8. For example, the digital receipt service 30 may have been granted access to certain sensitive client data 18 or financial data for a user, which is associated with a certain client device 12 in the computing environment 8. Similarly, certain client profile data stored in the client data 18 or financial data may include potentially sensitive information such as age, date of birth, or nationality, which may not necessarily be needed by the digital receipt service 30 to execute certain actions. As such, the access control module can be used to control the sharing of certain client profile data or other transaction data and/or financial data based on a type of client/user, a permission or preference, or any other restriction imposed by the computing environment 8 or application in which the digital receipt service 30 is used.

The various interfaces shown and described herein can include or take the form of an API, software development kit (SDK) or any other software, plug-in, agent, or tool that allows the digital receipt service 30 to be integrated with or within an application associated with the enterprise system 16, e.g., to store and fetch data for issuing digital receipts, either in real-time or later.

In FIG. 9, an example configuration of the enterprise system 16 is shown. The enterprise system 16 includes a communications module 130 that enables the enterprise system 16 to communicate with one or more other components of the computing environment 8, such as a POS device 10, client device 12 (or one of its components), via a bus or other communication network, such as the communication network 14. While not delineated in FIG. 9, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 9 illustrates examples of servers and datastores/databases operable within the enterprise system 16.

It can be appreciated that any of the components shown in FIG. 9 may also be hosted externally and be available to the enterprise system 16, e.g., via the communications module 130. In the example embodiment shown in FIG. 9, the enterprise system 16 includes one or more servers to provide access to the client data 18 (which may be included with other financial data or stored separately as shown in FIG. 1) to enable the digital receipt service 30 to interface with the components shown in, for example, FIGS. 2 and 3 to provide device agnostic services such as for issuing and storing digital receipts. Exemplary servers include a mobile application server 132 and a web application server 134. Although not shown in FIG. 9, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storages for storing and providing data for use in such services, such as data storage for storing financial data.

Mobile application server 132 supports interactions with a mobile application installed on client device 12. Mobile application server 132 can access other resources of the enterprise system 16 to carry out requests made by, and to provide content and data to, a mobile application on client device 12. In certain example embodiments, mobile application server 132 supports a mobile banking or insurance application.

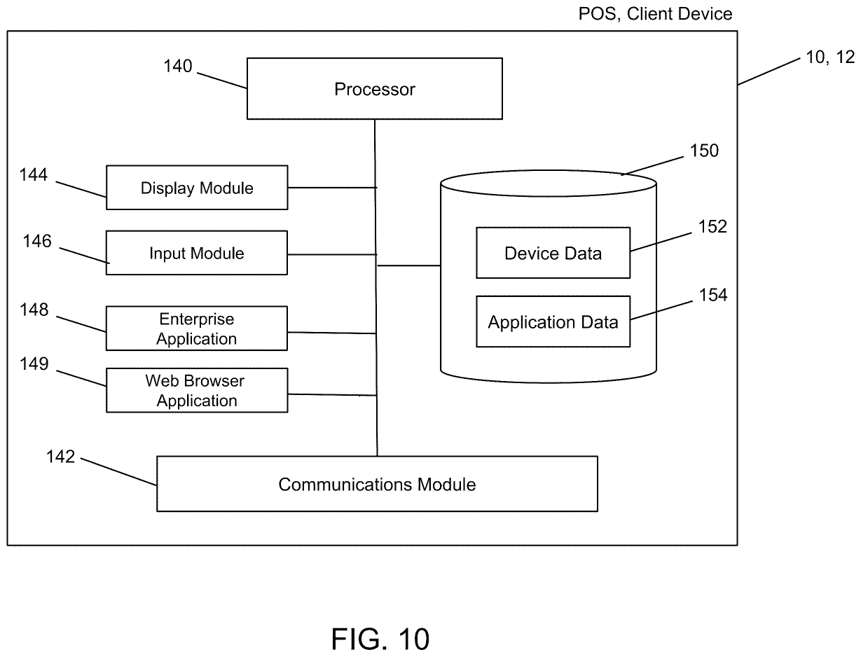

Web application server 134 supports interactions using a website accessed by a web browser application 149 (see FIG. 10) running on the client device 12. It can be appreciated that the mobile application server 132 and the web application server 134 can provide different front ends for the same application, that is, the mobile (app) and web (browser) versions of the same application. For example, the enterprise system 16 may provide an insurance or banking application that be accessed via a smartphone or tablet app while also being accessible via a browser 149 on any browser-enabled device.

The client data 18 (e.g., financial data) may be associated with users of the client devices 12 (e.g., customers of a financial institution). The financial data may include any data related to or derived from financial values or metrics associated with customers of the enterprise system 16, for example, account balances, transaction histories, line of credit available, credit scores, mortgage balances, affordability metrics, investment account balances, investment values and types, insurance policies, insurability metrics, among many others. Other metrics can be associated with the financial data, such as financial health data that is indicative of the financial health of the users of the client devices 12. As indicated above, it can be appreciated that the client data 18 shown in FIG. 1 may include or be part of the financial data held by the enterprise system 16 and a single database 18 is shown for ease of illustration.

In FIG. 10, an example configuration of a POS device 10 or client device 12 is shown. In certain embodiments, the POS or client device 10, 12 may include one or more processors 140, a communications module 142, and a data store 150 storing device data 152 and application data 154. Communications module 142 enables the POS or client device 10, 12 to communicate with one or more other components of the computing environment 8, such as the enterprise system 16, via a bus or other communication network, such as the communication network 14. While not delineated in FIG. 10, the POS 10 or client device 10, 12 includes at least one memory or memory device that can include a tangible and non-transitory computer-readable medium having stored therein computer programs, sets of instructions, code, or data to be executed by processor 140. FIG. 10 illustrates examples of modules and applications stored in memory on the POS or client device 10, 12 and operated by the processor 140. It can be appreciated that any of the modules and applications shown in FIG. 10 may also be hosted externally and be available to the POS device 10 or client device 12, e.g., via the communications module 142.

In the example embodiment shown in FIG. 10, the POS or client device 10, 12 includes a display module 144 for rendering GUIs and other visual outputs on a display device such as a display screen, and an input module 106 for processing user or other inputs received at the POS or client device 10, 12, e.g., via a touchscreen, input button, transceiver, microphone, keyboard, etc. The POS or client device 10, 12 may also include an enterprise application 148 provided by the enterprise system 16, e.g., for performing mobile insurance, banking, or other financial product or services. The POS or client device 10, 12 in this example embodiment also includes a web browser application 149 for accessing Internet-based content, e.g., via a mobile or traditional website. The data store 150 may be used to store device data 152, such as, but not limited to, an IP address or a MAC address that uniquely identifies the POS or client device 10, 12 within environment 8. The data store 150 may also be used to store application data 154, such as, but not limited to, login credentials, user preferences, cryptographic data (e.g., cryptographic keys), etc.

It will be appreciated that only certain modules, applications, tools and engines are shown in FIGS. 2 to 3 and 8 to 10 for ease of illustration and various other components would be provided and utilized by enterprise system 16, POS device 10, and client device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A system for providing device agnostic services, the system comprising:
a transaction device;
a transaction participant system;
a processor; and
a memory coupled to the processor, the memory storing computer executable instructions that when executed by the processor cause the system to:
provide a device agnostic gateway comprising a service gateway, a device proxy, and a web proxy, wherein the service gateway enables communication between the transaction device and an authorization service, and wherein the device proxy and the web proxy provide a communication channel between the transaction device and the transaction participant system;
receive, from a client device, a request to complete a transaction, the request comprising identifying information;
by the transaction device, process the request to complete the transaction via a service provider, the transaction requiring the transaction participant system;
receive a token based on the identifying information of the request and provide the token to the device agnostic gateway;
transmit, with the device agnostic gateway, the token to a subsystem of the transaction participant system;
store, in the subsystem, the token in association with transaction details of the transaction available to the transaction participant system; and
provide, via the transaction participant system, the transaction details in response to receiving the identifying information.

2. The system of claim 1, wherein the token is generated by the service provider and the identifying information comprises sensitive payment information.

3. The system of claim 1, wherein the transaction device is a point of sale device, the transaction participant system is a financial institution, and the transaction details include a digital receipt.

4. The system of claim 1, wherein the transaction device is configured to process the transaction prior to receiving the token.

5. The system of claim 1, wherein the transaction is completed via another channel, and the token is provided to the device agnostic gateway via the communication channel.

6. The system of claim 5, wherein the device agnostic gateway parses traffic received via the communication channel and determines whether the transaction device is authenticated for the device agnostic gateway.

7. The system of claim 1, wherein the transaction details are provided automatically in response to the token being submitted to the subsystem.

8. The system of claim 1, wherein the instructions cause the system to:
receive a subsequent request comprising subsequent identifying information for the transaction details from a further device;
query the service provider for a subsequent token based on the subsequent identifying information; and
in response to determining that the subsequent token matches the token, provide the further device with the transaction details.

9. The system of claim 8, wherein the instructions cause the system to:
store transaction details in a database on the subsystem in association with the token; and
in response to the subsequent token matching the token, return stored transaction details in the database.

10. The system of claim 1, further comprising a notification system responsible for managing notification preferences, wherein the instructions cause the system to:
in response to the subsystem receiving the token, transmitting, by the subsystem, a notification to the notification system.

11. The system of claim 10, wherein the notification system generates a notification with the transaction details and transmits the notification with the transaction details to a client device associated with the token.

12. The system of claim 10, wherein the notification system is an event notification system for the transaction participant system, and the event notification system transmits notifications via a selected channel with the transaction details.

13. The system of claim 1, wherein the device agnostic gateway provides another channel for communication with client devices for subsequent requests for the transaction details.

14. A method for providing device agnostic services, the method comprising:
providing a device agnostic gateway comprising a service gateway, a device proxy, and a web proxy, wherein the service gateway enables communication between the transaction device and an authorization service, and wherein the device proxy and the web proxy provide a communication channel between a transaction device and a transaction participant system;
receiving, from a client device, a request to complete a transaction, the request comprising identifying information;
by the transaction device, processing the request to complete the transaction via a service provider, the transaction requiring the transaction participant system;
receiving a token based on the identifying information of the request and provide the token to the device agnostic gateway;
transmitting, with the device agnostic gateway, the token to a subsystem of the transaction participant system;
storing, in the subsystem, the token in association with transaction details of the transaction available to the transaction participant system; and
providing, via the transaction participant system, the transaction details in response to receiving the identifying information.

15. The method of claim 14, wherein the token is generated by the service provider and the identifying information comprises sensitive payment information.

16. The method of claim 15, wherein the transaction device is a point of sale device, the transaction participant system is a financial institution, and the transaction details include a digital receipt.

17. The method of claim 14, wherein the transaction device is configured to process the transaction prior to receiving the token.

18. The method of claim 14, comprising:
receiving a subsequent request comprising subsequent identifying information for the transaction details from a further device;
querying the service provider for a subsequent token based on the subsequent identifying information; and
in response to determining that the subsequent token matches the token, provide the further device with the transaction details.

19. The method of claim 14, wherein the device agnostic gateway provides another channel for communication with client devices for subsequent requests for the transaction details.

20. (canceled)

21. The method of claim 14, wherein the transaction details are provided automatically in response to the token being submitted to the subsystem.
